(19) United States
(12) Patent Application Publication
(10) Pub. No.: US 2025/0296215 A1
(43) Pub. Date: Sep. 25, 2025

(54) TOOL BIT HOLDER WITH SLEEVE KEYED TO SPINDLE

(71) Applicant: MILWAUKEE ELECTRIC TOOL CORPORATION, Brookfield, WI (US)

(72) Inventors: Kentez L. Craig, Milwaukee, WI (US); Nicholas J. Losch, Hales Corners, WI (US)

(21) Appl. No.: 19/088,448

(22) Filed: Mar. 24, 2025

Related U.S. Application Data
(60) Provisional application No. 63/568,916, filed on Mar. 22, 2024.

(51) Int. Cl. B25D 17/08

(52) U.S. Cl. CPC B25D 17/088; B25D 2217/003

(57) ABSTRACT

A power tool includes a spindle rotatable about an axis and a bit holder supported by the spindle, the bit holder including a recess configured to receive a tool bit to couple the tool bit for co-rotation with the spindle about the axis. The bit holder further includes a sleeve movable along the axis between a locked position, in which the bit holder prevents removal of the tool bit from the recess, and an unlocked position, in which the tool bit is removable from the recess. The sleeve is coupled for co-rotation with the spindle.

### CROSS-REFERENCE TO RELATED APPLICATIONS

This application claims priority to U.S. Provisional Patent Application No. 63/568,916, filed Mar. 22, 2024, the entire content of which is incorporated herein by reference.

### FIELD

The present disclosure relates to tool bit holders for power tools.

### BACKGROUND

Tool bit holders may include a sleeve movable axially against a spring to release a tool bit from the tool bit holder.

### SUMMARY

The sleeve of such tool bit holders is rotatable relative to a spindle of the power tool. The inventors have found that rotation of the sleeve can cause wear on the spring. Accordingly, a need exists for a tool bit holder with a sleeve that is not rotatable relative to the spindle to improve the durability of the tool bit holder.

For example, in some aspects, the techniques described herein relate to a power tool including: a spindle rotatable about an axis; and a bit holder supported by the spindle, the bit holder including a recess configured to receive a tool bit to couple the tool bit for co-rotation with the spindle about the axis, the bit holder including a sleeve movable along the axis between a locked position, in which the bit holder prevents removal of the tool bit from the recess, and an unlocked position, in which the tool bit is removable from the recess, wherein the sleeve is coupled for co-rotation with the spindle.

In some aspects, the techniques described herein relate to a bit holder for coupling a tool bit for co-rotation with a spindle of a power tool, the bit holder including: a recess configured to receive a tool bit to couple the tool bit for co-rotation with the spindle about an axis; and a sleeve movable along the axis between a locked position, in which the bit holder prevents removal of the tool bit from the recess, and an unlocked position, in which the tool bit is removable from the recess, wherein the sleeve includes a key engageable with the spindle to couple the sleeve for co-rotation with the spindle.

In some aspects, the techniques described herein relate to a power tool including: a spindle rotatable about an axis; a bit holder supported by the spindle, the bit holder including a recess configured to receive a tool bit to couple the tool bit for co-rotation with the spindle about the axis, a sleeve movable along the axis between a locked position, in which the bit holder prevents removal of the tool bit from the recess, and an unlocked position, in which the tool bit is removable from the recess, and a biasing element biasing the sleeve toward the locked position, wherein the sleeve is keyed to the spindle.

Other aspects of the disclosure will become apparent by consideration of the detailed description and accompanying drawings.

### BRIEF DESCRIPTION OF THE DRAWINGS

FIG. 1 is perspective view of a portion of a power tool including a transmission housing, a bit holder, and a spindle.

FIG. 2A is a section view of the portion of the power tool of FIG. 1.

FIG. 2B is another section view of the portion of the power tool of FIG. 1.

FIG. 3 is a perspective view of the spindle of FIG. 1.

FIG. 4 is a section view of a sleeve of the bit holder of FIG. 1.

FIG. 5 is a perspective view of an elastic member of the bit holder of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

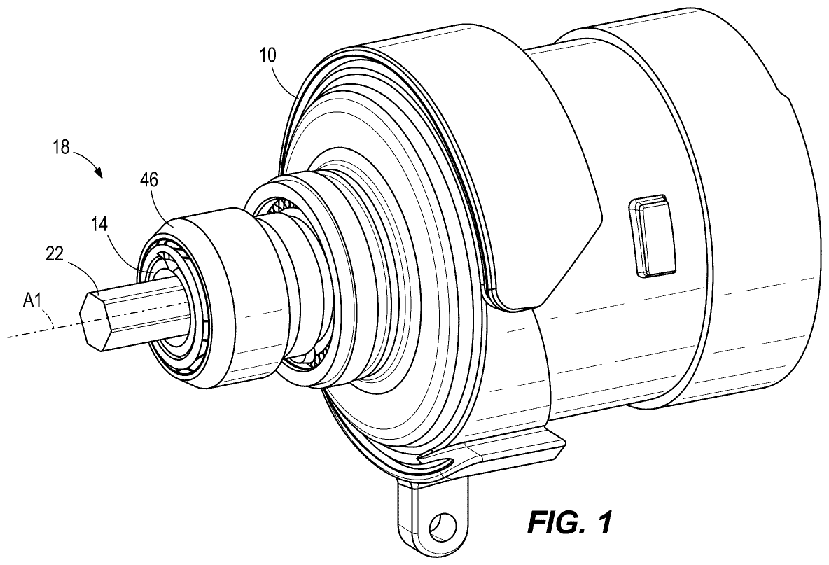

FIG. 1 illustrates a portion of a power tool including a front housing 10, a spindle 14, and a bit holder 18. The power tool of the illustrated embodiment is a rotary impact tool (i.e., an impact driver), and as such, the illustrated spindle 14 is an anvil of the rotary impact tool. In other embodiments the power tool may be a drill, ratchet tool, powered screwdriver, or any other type of rotary power tool. The front housing 10 may enclose a portion of a drive train (e.g., a transmission, an impact mechanism, etc.) of the power tool, which transmits torque from a motor (not shown) to the spindle 14 (e.g., as periodic rotational impacts or as a continuous torque). The front housing 10 also rotatably supports the spindle 14 via a bushing, bearing, or the like. The spindle 14 receives a tool bit 22 such that the tool bit 22 is coupled for co-rotation with the spindle 14 about a central axis A1. The bit holder 18 selectively retains the tool bit 22 in the spindle 14.

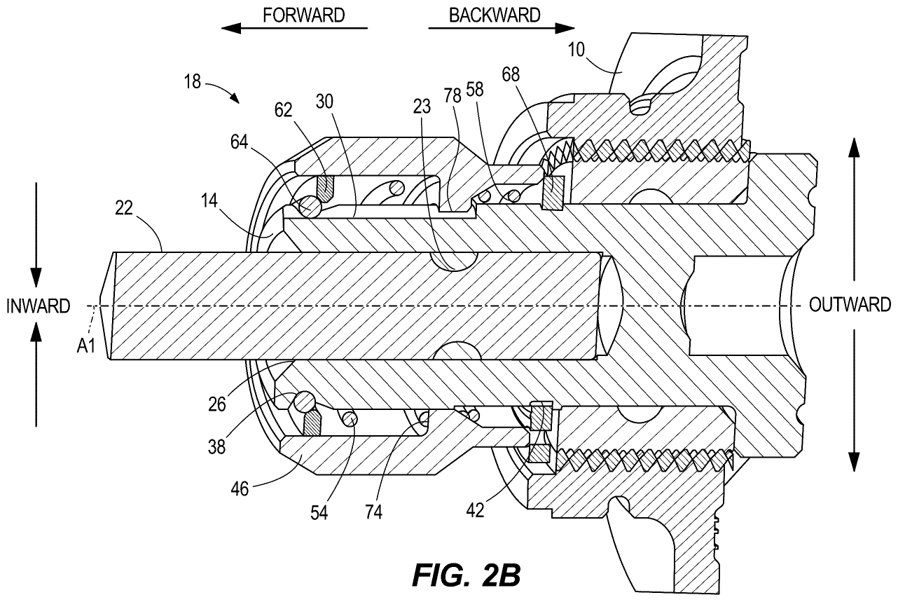

Referring to FIG. 3, the illustrated spindle 14 includes a recess 26, a keyway 30, a slot 34, a first retention groove 38, and a second retention groove 42. The recess 26 has a hexagonal cross-section to match the hexagonal cross-section of the tool bit 22. In other embodiments, the recess 26 may have a square cross-section, a splined cross-section, a D-shaped cross-section, or another shape depending on the tool bit 22 to be received by the power tool. The keyway 30 may extend fully or partially through the spindle 14 and extends in a direction parallel to the central axis A1. In the illustrated embodiment, the keyway 30 is formed only along a portion of the entire length of spindle 14. The slot 34 is also formed on the circumference of the spindle 14 and is circumferentially offset from the keyway 30. The slot 34 extends through the spindle 14 and into the recess 26. The first retention groove 38 intersects the keyway 30 in the illustrated embodiment. The second retention groove 42 is located adjacent a rear end of the slot 34 and is axially offset from the first retention groove 38.

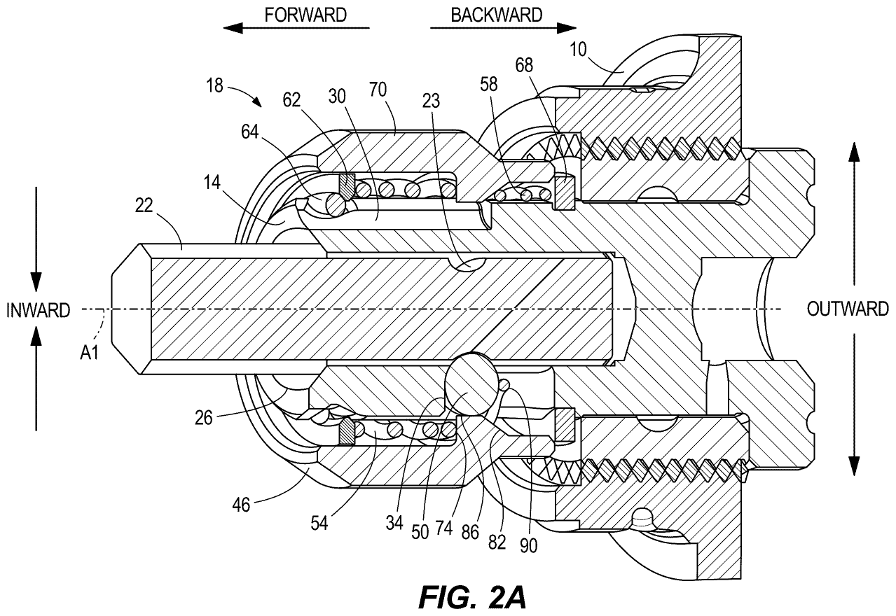

The bit holder 18 includes a sleeve 46 surrounding the spindle 14 and that is moveable along the axis A1 between a locked position (FIGS. 2A-2B) and an unlocked position (not shown). In the locked position, the tool bit 22 is retained within the recess 26 in the spindle 14. That is, the bit holder 18 prevents removal of the tool bit 22 from the recess 26. In the unlocked position, the tool bit 22 may be freely moved in or out of the recess 26. The illustrated bit holder 18 includes the sleeve 46, a bit retaining member 50, a first biasing element 54, a second biasing element 58, a first retaining ring 62, an o-ring 64, and a second retaining ring 68, the functions of which are described in greater detail below.

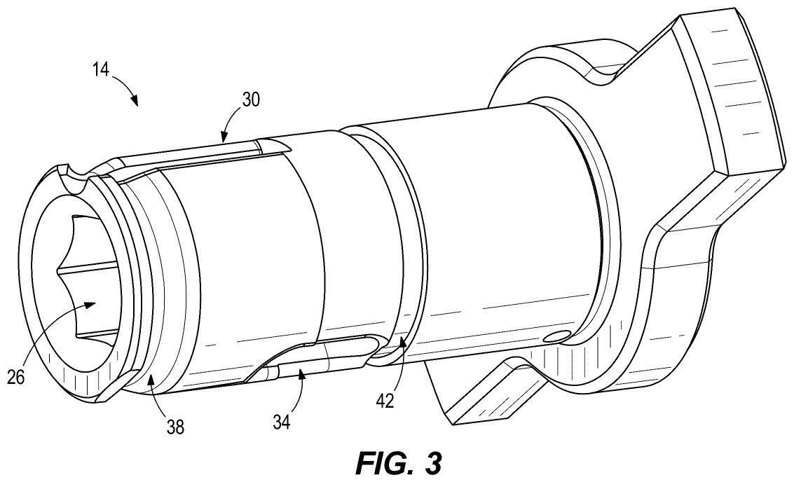

Referring to FIGS. 2A-2B and 4, the sleeve 46 includes an outer surface 70, an inner surface 71, a shoulder 74, and a key 78. The outer surface 70 is graspable by a user to move the sleeve 46 axially along the central axis A1. The shoulder 74 extends radially inwardly from the inner surface 71. The illustrated shoulder 74 includes a ramped surface 82 and an axial surface 86 extending from the ramped surface 82 parallel to the inner surface 71 and to the central axis A1. The key 78 is formed as a rounded lobe in the illustrated embodiment and extends radially inwardly from the shoulder 74.

The key 78 is shaped to fit within the keyway 30 (FIG. 2B) to inhibit rotation of the sleeve 46 around the central axis A1. That is, the engagement between the key 78 and keyway 30 couples the sleeve 46 for co-rotation with the spindle 14. The key 78 is configured to slide axially along the keyway 30 as the sleeve 46 is moved along the central axis A1. In other embodiments, the sleeve 46 and the spindle 14 may include other cooperating geometric features to couple the sleeve 46 for co-rotation with the spindle 14 while permitting axial movement of the sleeve 46 along the spindle 14. For example, the spindle 14 may include the key 78, and the sleeve 46 may include the keyway 30. In other embodiments, multiple keys and keyways may be provided on the sleeve 46 and the spindle 14. In yet other embodiments, the spindle 14 and the sleeve 46 may have non-round (e.g., square, hexagonal, splined, etc.) cross-sectional shapes.

In the illustrated embodiment, the bit retaining member 50 is a spherical ball and is positioned in the slot 34 of the spindle 14 (FIG. 2A). The bit retaining member 50 is moveable both axially in the slot 34 and radially with respect to the recess 26. In the locked position of the bit holder 18, the bit retaining member 50 contacts the axial surface 86 of the sleeve 46 and is held in a radially inward position, in which the bit retaining member 50 extends through the slot 34 into the recess 26, as shown in FIG. 2A, to be received within a circumferential groove 23 formed in the tool bit 22. The bit retaining member 50 thereby prevents removal of the tool bit 22 from the recess 26. In the unlocked position of the bit holder 18, the sleeve 46 is pulled forward so that the axial surface 86 is positioned forward of the bit retaining member 50. This allows the bit retaining member 50 to move radially outwardly, and out of the groove 23 in the tool bit 22 to permit removal of the tool bit 22 from the recess 26.

With continued reference to FIG. 2B, the first biasing element 54 is positioned around the spindle 14, between the shoulder 74 and the first retaining ring 62. In the illustrated embodiment, the first retaining ring 62 is retained in the forward axial direction by the o-ring 64, which is seated within the first retention groove 38 of the spindle 14. In some embodiments, the o-ring 64 may be omitted, and the first retaining ring 62 may be seated directly within the first retention groove 38. The first biasing element 54 biases the sleeve 46 in the backward direction and maintains the bit holder 18 in the locked position when no force is applied to the sleeve 46. In the illustrated embodiment, the first biasing element 54 is a coil spring; however, the first biasing element 54 may alternatively include a disc spring, one or more spring washers, repelling magnets, or the like.

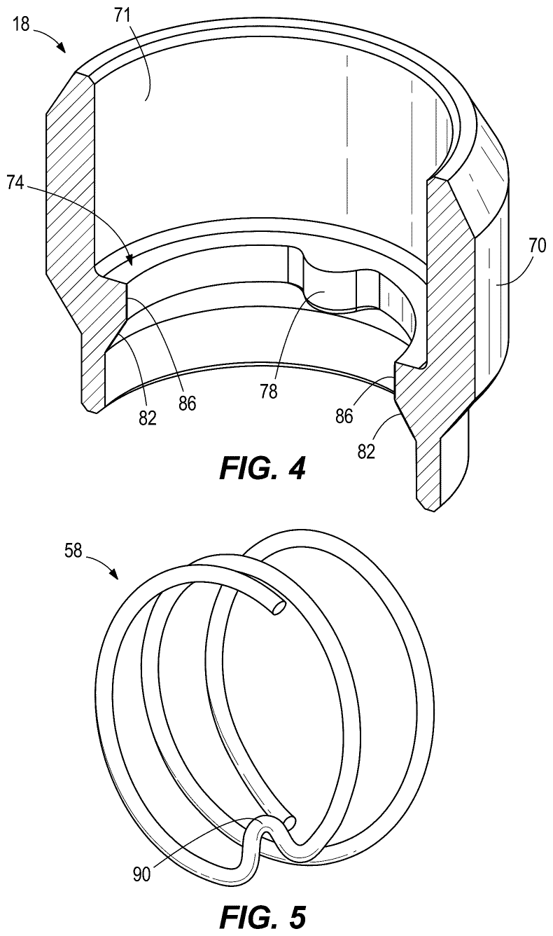

The second biasing element 58 is positioned around the spindle 14 and between the shoulder 74 and the second retaining ring 68, which is seated in the second retention groove 42. As shown in FIG. 5, the second biasing element 58 includes an inward projection 90, which engages and applies a biasing force to the bit retaining member 50 in the forward direction. The biasing force applied to the bit retaining member 50 maintains the axial position of the bit retaining member 50 in the locked position. Additionally, when transitioning between the unlocked and locked positions, the biasing force applied by the second biasing element 58 assists in moving the bit retaining member 50 in the forward direction. Finally, during insertion of the tool bit 22, the second biasing element 58 is compressible to permit rearward movement of the bit retaining member 50 beyond the axial surface 86 of the sleeve 46 to provide clearance for inserting the tool bit 22 without requiring forward movement of the sleeve 46.

In use, a user may insert the tool bit 22 into the bit holder 18 simply by aligning the tool bit 22 with the recess 26 and sliding the tool bit 22 into the recess. Once the rear end of the tool bit 22 contacts the bit retaining member 50, continued movement of the tool bit 22 into the recess 26 causes the bit retaining member 50 to move backward, compressing the second biasing element 58. As the bit retaining member 50 moves backward, it moves past the axial surface 86 of the sleeve 46 and then radially outwardly along the ramped surface 82. As the bit retaining member 50 moves backward and radially outwardly along the ramped surface 82, sufficient clearance is formed in the recess 26 to permit full insertion of the tool bit 22. As the tool bit 22 is fully inserted, the groove 23 in the tool bit 22 comes into alignment with the slot 34, and the second biasing element 58 pushes the bit retaining member 50 forward along the ramped surface 82 and radially inward, into the groove 23 in the tool bit 22, until the bit retaining member 50 is in its forward, locked position (FIG. 2A). The tool bit 22 is thus locked in place, as the axial surface 86 prevents radially outward movement of the bit retaining member 50 if a forward pulling force is applied to the tool bit 22. To unlock the bit holder 18, the user grasps the sleeve 46 and pulls the sleeve 46 forward, against the biasing force of the first biasing element 54. The engagement between the key 78 and the keyway 30 prevents the sleeve 46 from rotating (FIG. 2B), which prevents the first biasing element 54 from being subjected to torsion. As the sleeve 46 is moved forward, the bit retaining member 50 is able to travel radially outwardly along the ramped surface 82 and out of engagement with the groove 23. The tool bit 22 can then be freely withdrawn from the recess 26.

Various features and aspects of the present disclosure are set forth in the following claims.

What is claimed is:

1. A power tool comprising:
a spindle rotatable about an axis; and
a bit holder supported by the spindle, the bit holder including a recess configured to receive a tool bit to couple the tool bit for co-rotation with the spindle about the axis, the bit holder including a sleeve movable along the axis between a locked position, in which the bit holder prevents removal of the tool bit from the recess, and an unlocked position, in which the tool bit is removable from the recess,
wherein the sleeve is coupled for co-rotation with the spindle.

2. The power tool of claim 1, wherein the bit holder includes a bit retaining member configured to engage a groove in the tool bit when the sleeve is in the locked position.

3. The power tool of claim 1, wherein the sleeve is biased toward the locked position by a biasing element.

4. The power tool of claim 3, wherein the biasing element is a coil spring.

5. The power tool of claim 3, wherein the biasing element extends between a retaining ring and a shoulder on the sleeve.

6. The power tool of claim 1, wherein the sleeve and the spindle include cooperating geometric features that couple the sleeve for co-rotation with the spindle.

7. The power tool of claim 6, wherein the cooperating geometric features include a key formed on the sleeve and a keyway formed in the spindle.

8. A bit holder for coupling a tool bit for co-rotation with a spindle of a power tool, the bit holder comprising:
a recess configured to receive a tool bit to couple the tool bit for co-rotation with the spindle about an axis; and
a sleeve movable along the axis between a locked position, in which the bit holder prevents removal of the tool bit from the recess, and an unlocked position, in which the tool bit is removable from the recess,
wherein the sleeve includes a key engageable with the spindle to couple the sleeve for co-rotation with the spindle.

9. The bit holder of claim 8, wherein the recess has a hexagonal cross-section.

10. The bit holder of claim 8, wherein the spindle includes a keyway at least partially extending through the spindle in a direction parallel to the axis, and wherein the key is configured to slide axially along the keyway as the sleeve is moved along the axis.

11. The bit holder of claim 8, wherein the bit holder includes a bit retaining member, the bit retaining member is held in a radially inward position within the recess and biased into a groove formed into the tool bit to prevent removal of the tool bit from the recess in the locked position, and wherein the bit retaining member is movable to a radially outward position out of the groove to permit removal of the tool bit from the recess in the unlocked position.

12. The bit holder of claim 11, wherein the bit retaining member is biased toward the locked position by a first biasing element, and wherein the bit retaining member is biased toward the unlocked position by a second biasing element.

13. The bit holder of claim 12, wherein the first biasing element and the second biasing element surround the spindle.

14. A power tool comprising:
a spindle rotatable about an axis;
a bit holder supported by the spindle, the bit holder including a recess configured to receive a tool bit to couple the tool bit for co-rotation with the spindle about the axis, a sleeve movable along the axis between a locked position, in which the bit holder prevents removal of the tool bit from the recess, and an unlocked position, in which the tool bit is removable from the recess, and a biasing element biasing the sleeve toward the locked position,
wherein the sleeve is keyed to the spindle.

15. The power tool of claim 14, further comprising a hammer, wherein the spindle is an anvil configured to receive periodic rotational impacts from the hammer.

16. The power tool of claim 14, wherein the bit holder includes a bit retaining member engageable with the tool bit to prevent removal of the tool bit from the recess when the sleeve is in the locked position, and movable in a radially outward direction to permit removal of the tool bit from the recess when the sleeve is in the unlocked position.

17. The power tool of claim 16, wherein the biasing element surrounds the spindle.

18. The power tool of claim 17, wherein the biasing element is a first biasing element, and wherein the bit holder further includes a second biasing element surrounding the spindle.

19. The power tool of claim 18, wherein the second biasing element includes a projection that engages the bit retaining member.

20. The power tool of claim 14, wherein the spindle includes a keyway at least partially extending through the spindle in a direction parallel to the axis, and wherein the keyway is engageable with a key on the sleeve to couple the sleeve for co-rotation with the spindle.
